(19) United States
(12) Patent Application Publication
(10) Pub. No.: US 2009/0098453 A1
(43) Pub. Date: Apr. 16, 2009

(54) Anode of lithium battery, method for fabricating the same, and lithium battery using the same

(75) Inventors: Chang-Hong Liu, Bei-JIng (CN); Shou-Shan Fan, Bei-Jing (CN)

Correspondence Address: PCE INDUSTRY, INC.;ATT. Steven Reiss, 458 E. LAMBERT ROAD, FULLERTON, CA, 92835, US

(73) Assignees: Tsinghua University; Hon Hai Precision Industry Co., LTD.

(21) Appl. No.: 12/006,308

(22) Filed: Dec. 29, 2007

(30) Foreign Application Priority Data
Oct. 10, 2007 (CN) 200710123815.9

(51) Int. Cl. H01M 4/58; H01M 2/00

(52) U.S. Cl. 429/163; 429/231.8; 423/447.1; 977/742; 977/842

(57) ABSTRACT

An anode of a lithium battery includes a carbon nanotube film, the carbon nanotube film includes a plurality of tangled carbon nanotubes. A method for fabricating an anode of a lithium battery, the method includes the steps of:(a) providing a plurality of carbon nanotubes; (b) adding the plurality of carbon nanotubes to a solvent to get a carbon nanotube floccule structure in the solvent; and (c) separating the carbon nanotube floccule structure from the solvent, shaping the separated carbon nanotube floccule structure into a carbon nanotube film, and thereby, achieving the anode.

### RELATED APPLICATIONS

This application is related to commonly-assigned application entitled, “ANODE OF LITHIUM BATTERY, METHOD FOR FABRICATING THE SAME, AND LITHIUM BATTERY USING THE SAME”, filed ______ (Atty. Docket No. US16785). Disclosure of the above-identified application is incorporated herein by reference.

### BACKGROUND

1. Field of the Invention

The present invention relates to anodes of lithium batteries, methods for fabricating the same, and lithium batteries using the same, and, particularly, to a carbon-nanotube-based anode of a lithium battery, a method for fabricating the same, and a lithium battery using the same.

2. Discussion of Related Art

In recent years, lithium batteries have received a great deal of attention and are used in various portable devices, such as notebook PCs, mobile phones and digital cameras for their small weight, high discharge voltage, long cyclic life and high energy density compared with conventional lead storage batteries, nickel-cadmium batteries, nickel-hydrogen batteries, and nickel-zinc batteries.

An anode of a lithium battery should have such properties as high energy density; low open-circuit voltage versus metallic lithium electrodes; high capacity retention; good performance in common electrolytes; high density (e.g. >2.0 g/cm³); good stability during charge and discharge processes, and low cost. At present, the most widely used anode active material is carbonous/carbonaceous material such as natural graphite, artificial graphite and amorphous-based carbon. Amorphous-based carbon has excellent capacity, but the irreversibility thereof is relatively high. The theoretical maximum capacity of natural graphite is 372 mAh/g, but the lifetime thereof is generally short.

In general, carbonous/carbonaceous material anode has low efficiency and cycle performance in the first charge and discharge cycle due to the formation of Solid Electrolyte Interface (SEI) layer. A stable SEI layer is essential in the lithium battery to prevent anode material from reacting with the electrolyte, therefore, the selection of the electrolyte is limited. Only the electrolytes in which a stable SEI layer can be formed are suitable for using in a lithium battery.

Carbon nanotube are a novel carbonous/carbonaceous material formed by one layer or more layers of graphite. A distance between two layers of graphite in the carbon nanotube is about 0.34 nanometers, which is greater than the distance between two layers in natural graphite. Thus, carbon nanotube are a suitable material for using as the anode of the lithium battery. However, until now, carbon nanotubes are mixed with a binder and disposed on a current collector of the anode. As such, adsorption ability of the carbon nanotubes is restricted by the binder mixed therewith.

What is needed, therefore, is to provide an anode of a lithium battery and a method for fabricating the same, in which the above problems are eliminated or at least alleviated.

### SUMMARY

In one embodiment, an anode of a lithium battery includes a carbon nanotube film, the carbon nanotube film includes a plurality of tangled carbon nanotubes.

Other advantages and novel features of the present carbon-nanotube-based anode of lithium battery and the related method for fabricating the same will become more apparent from the following detailed description of preferred embodiments when taken in conjunction with the accompanying drawings.

### BRIEF DESCRIPTION OF THE DRAWINGS

Many aspects of the present carbon-nanotube-based anode of lithium battery and the related method for fabricating the same can be better understood with reference to the following drawings. The components in the drawings are not necessarily to scale, the emphasis instead being placed upon clearly illustrating the principles of the present carbon-nanotube-based anode of lithium battery and the related method for fabricating the same.

FIG. 1 is a schematic view of an anode of a lithium battery, in accordance with a present embodiment.

FIG. 2 is a flow chart of a method for fabricating the anode of the lithium battery of FIG. 1.

FIG. 3 shows a photo of a carbon nanotube floccule structure in the anode of the lithium battery of FIG. 1.

FIG. 4 shows a photo of a carbon nanotube film with a predetermined shape in the anode of the lithium battery of FIG. 1.

FIG. 5 is a schematic view a lithium battery, in accordance with the present embodiment.

Corresponding reference characters indicate corresponding parts throughout the several views. The exemplifications set out herein illustrate at least one preferred embodiment of the present carbon-nanotube-based anode of lithium battery and the related method for fabricating the same, in at least one form, and such exemplifications are not to be construed as limiting the scope of the invention in any manner.

### DETAILED DESCRIPTION OF PREFERRED EMBODIMENTS

Reference will now be made to the drawings to describe, in detail, embodiments of the present carbon-nanotube-based anode of lithium battery and related method for fabricating the same.

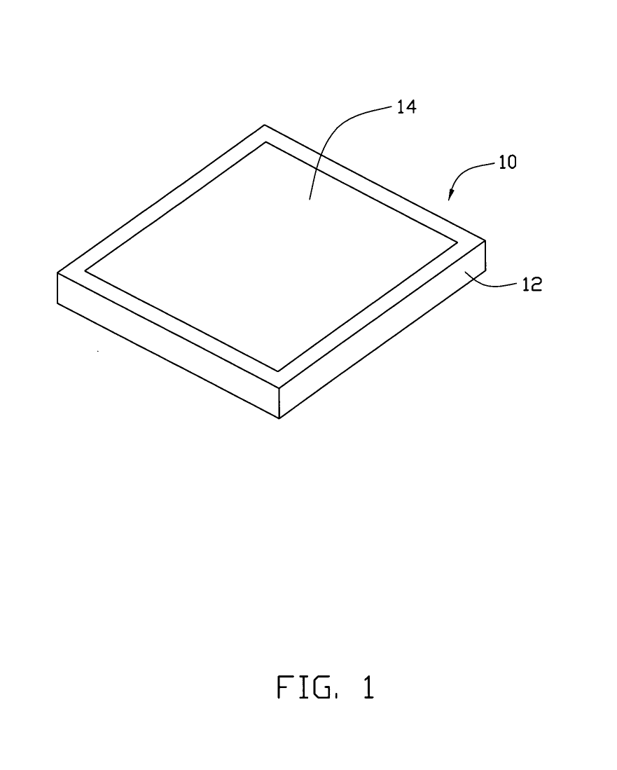

Referring to FIG. 1, an anode 10 of lithium battery in the present embodiment includes a current collector 12 and a carbon nanotube film 14 supported by the current collector 12. The current collector 12 can, beneficially, be a metal substrate. Quite suitably, the metal substrate is copper sheet. The carbon nanotube film 14 can, advantageously, be directly disposed on a surface of the current collector 12. More specifically, the carbon nanotube film 14 can be formed on the surface of the current collector 12 directly, or can be made to adhere to the surface of the current collector 12 by a binder.

The carbon nanotube film 14 is a free-standing film and includes a plurality of carbon nanotubes. The carbon nanotubes in the carbon nanotube film 14 are isotropic and uniformly arranged, disordered, and are entangled together. The carbon nanotube film 14 includes a plurality of micropores formed by the disordered carbon nanotubes. A diameter of the micropores is less than about 100 microns. As such, a specific area of the carbon nanotube film 14 is extremely large. Thus, when the carbon nanotube film 14 is used in the lithium battery anode, the intercalation amount of lithium ions can be enhanced and the stability of an SEI layer formed in the first charge/discharge cycle can be improved by the special microporous structure of the carbon nanotube film 14.

It is to be understood that, the current collector 12 in the anode 10 of the lithium battery in the present embodiment is optional. In other embodiments, the anode 10 of the lithium battery may only include the carbon nanotube film 14. Due to the free-standing and stable film structure, the carbon nanotube film 14 can be used as the anode 10 in the lithium battery without the current collector 12.

In the present embodiment, a width of the carbon nanotube film 14 is in the approximate range from 1 centimeter to 10 centimeters. A thickness of the carbon nanotube film 14 is in the approximate range from 1 micron to 2 millimeters. It is to be understood that, the size of the carbon nanotube film 14 may be arbitrarily set. After a cutting step, a smaller size (e.g. a 8 mm×8 mm) of carbon nanotube film can be formed for use as the carbon-nanotube-based anode in a miniature lithium battery.

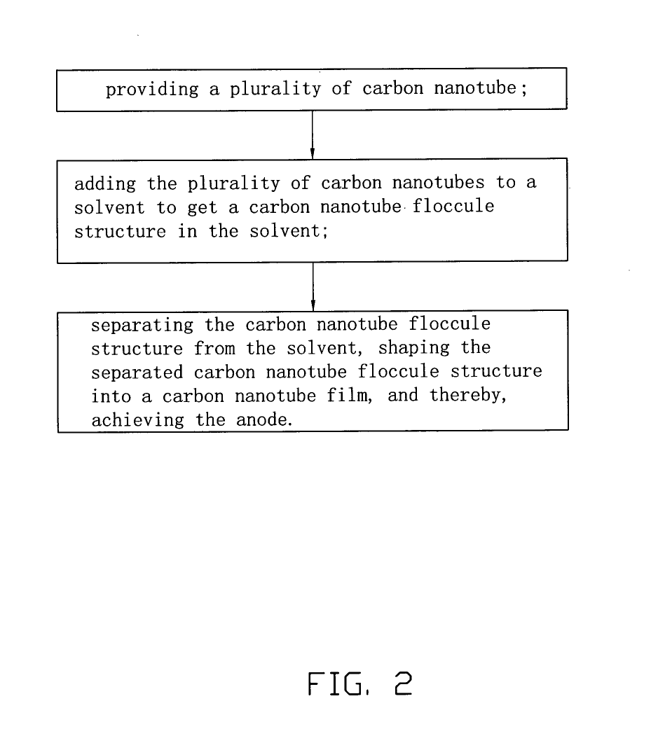

Referring to FIG. 2, a method for fabricating the anode 10 of the lithium battery includes the steps of: (a) providing a plurality of carbon nanotubes; (b) adding the plurality of carbon nanotubes to a solvent to get a carbon nanotube floccule structure in the solvent; and (c) separating the carbon nanotube floccule structure from the solvent, and shaping the separated carbon nanotube floccule structure into a carbon nanotube film, and thereby, achieving the anode of the lithium battery.

In step (a), the plurality of carbon nanotubes is formed in the present embodiment by the substeps of: (a1) providing a substantially flat and smooth substrate; (a2) forming a catalyst layer on the substrate; (a3) annealing the substrate with the catalyst layer in air at a temperature in the approximate range from 700° C. to 900° C. for about 30 to 90 minutes; (a4) heating the substrate with the catalyst layer to a temperature in the approximate range from 500° C. to 740° C. in a furnace with a protective gas therein; (a5) supplying a carbon source gas to the furnace for about 5 to 30 minutes and growing a super-aligned array of carbon nanotubes on the substrate; and (a6) separating the array of carbon nanotubes from the substrate to get the plurality of carbon nanotubes .

In step (a1), the substrate can be a P or N-type silicon wafer. Quite suitably, a 4-inch P-type silicon wafer is used as the substrate.

In step (a2), the catalyst can, advantageously, be made of iron (Fe), cobalt (Co), nickel (Ni), or any combination alloy thereof.

In step (a4), the protective gas can, beneficially, be made up of at least one of nitrogen (N₂), ammonia (NH₃), and a noble gas. In step (a5), the carbon source gas can, advantageously, be a hydrocarbon gas, such as ethylene (C₂H₄), methane (CH₄), acetylene (C₂H₂), ethane (C₂H₆), or any combination thereof.

The super-aligned array of carbon nanotubes can, opportunely, have a height above 100 microns and include a plurality of carbon nanotubes parallel to each other and approximately perpendicular to the substrate. Because the length of the carbon nanotubes is very long, portions of the carbon nanotubes are tangled together. Moreover, the super-aligned array of carbon nanotubes formed under the above conditions is essentially free of impurities such as carbonaceous or residual catalyst particles. The carbon nanotubes in the super-aligned array are closely packed together by the van der Waals attractive force.

In step (a6), the array of carbon nanotubes is scraped off the substrate by a knife or other similar devices to obtain a plurality of carbon nanotubes. Such a raw material is, to a certain degree, able to maintain the bundled state of the carbon nanotubes. The length of the carbon nanotubes is above 10 microns.

In step (b), the solvent is selected from a group consisting of water and volatile organic solvent. After adding the plurality of carbon nanotubes to the solvent, a process of flocculating the carbon nanotubes can, suitably, be executed to create the carbon nanotube floccule structure. The process of flocculating the carbon nanotubes can, beneficially, be selected from the group consisting of ultrasonic dispersion of the carbon nanotubes and agitating the carbon nanotubes. Quite usefully, in this embodiment ultrasonic dispersion is used to flocculate the solvent containing the carbon nanotubes for about 10˜30 minutes. Due to the carbon nanotubes in the solvent having a large specific surface area and the tangled carbon nanotubes having a large van der Waals attractive force, the flocculated and tangled carbon nanotubes form a network structure (i.e., floccule structure).

In step (c), the process of separating the floccule structure from the solvent includes the substeps of: (c1) filtering out the solvent to obtain the carbon nanotube floccule structure; and (c2) drying the carbon nanotube floccule structure to obtain the separated carbon nanotube floccule structure.

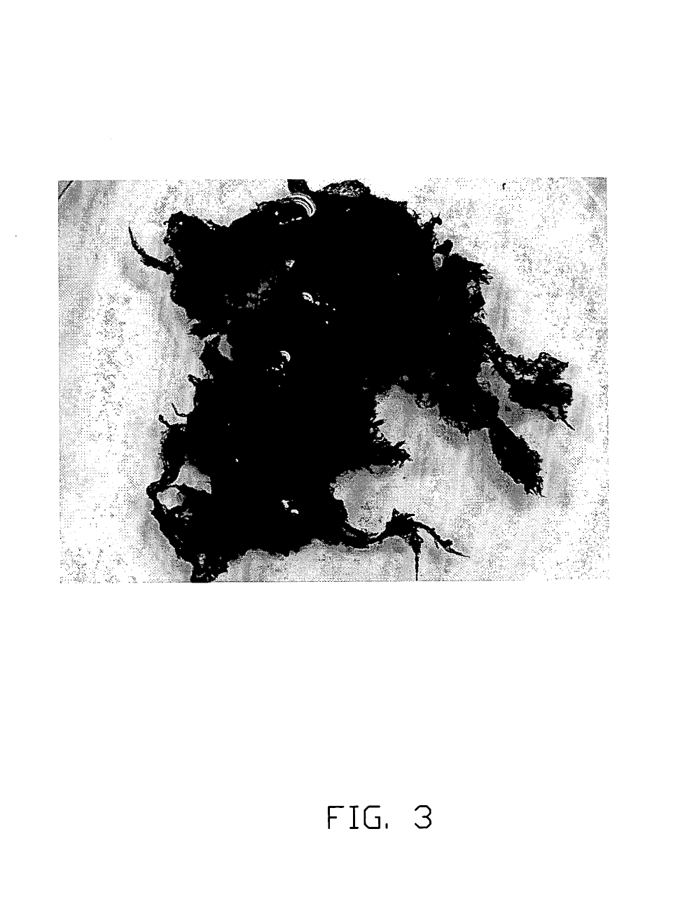

In step (c2), the carbon nanotube floccule structure can be disposed in room temperature for a period of time to dry the organic solvent therein. The time of drying can be selected according to practical needs. Referring to FIG. 3, on the filter, the carbon nanotubes in the carbon nanotube floccule structure are tangled together.

In step (c), the process of shaping includes the substeps of: (c3) putting the separated carbon nanotube floccule structure into a container (not shown), and spreading the carbon nanotube floccule structure to form a predetermined structure; (c4) pressing the spread carbon nanotube floccule structure with a certain pressure to yield a desirable shape; and (c5) removing the residual solvent contained in the spread floccule structure to form the carbon nanotube film 14.

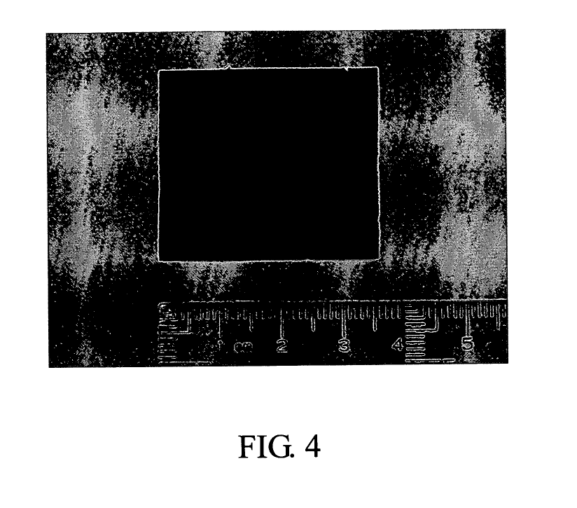

It is to be understood that the size of the spread floccule structure is, advantageously, used to control a thickness and a surface density of the carbon nanotube film 14. As such, the larger the area of the floccule structure, the less the thickness and density of the carbon nanotube film 14. Referring to FIG. 4, in the embodiment, the thickness of the carbon nanotube film 14 is in the approximate range from 1 micron to 2 millimeters, and the width of the carbon nanotube film 14 can, opportunely, be in the approximate range from 1 centimeter to 10 centimeters.

Further, the step (c) can be accomplished by a process of pumping and filtering the carbon nanotube floccule structure to obtain the carbon nanotube film. The process of pumping filtration includes the substeps of: (c1′) providing a microporous membrane and an air-pumping funnel; (c2′) filtering out the solvent from the flocculated carbon nanotubes through the microporous membrane using the air-pumping funnel; and (c3′) air-pumping and drying the flocculated carbon nanotubes attached on the microporous membrane.

In step (c1′), the microporous membrane has a smooth surface. And a diameter of the micropores in the membrane is about 0.22 microns. The pumping filtration can exert air pressure on the floccule structure, thus, forming a uniform carbon nanotube film 14. Moreover, due to the microporous membrane having a smooth surface, the carbon nanotube film can, beneficially, be easily separated.

Through the flocculating step, the carbon nanotubes are tangled together by van der Walls attractive force to form a network structure/floccule structure. Thus, the carbon nanotube film 14 has good tensile strength. The carbon nanotube film 14 includes a plurality of micropores formed by the disordered carbon nanotubes. A diameter of the micropores is less than about 100 micron. As such, a specific area of the carbon nanotube film 14 is extremely large. Additionally, the carbon nanotube film is essentially free of binder and includes a large amount of micropores. Accordingly, when the carbon nanotube film 14 is used in the lithium battery anode, the intercalation amount of lithium ions can be enhanced and the stability of the SEI layer formed in the first charge/discharge cycle can be improved by the special microporous structure of the carbon nanotube film 14. Further, the method for making the carbon nanotube film 14 is simple and can be used in mass production. A result of the production process of the method, is that thickness and surface density of the carbon nanotube film are controllable.

It will be apparent to those having ordinary skill in the field of the present invention that the size of the carbon nanotube film 14 can be arbitrarily set and depends on the actual needs of utilization (e.g. a miniature lithium battery). The carbon nanotube film 14 can be cut into smaller sizes in open air.

An additional step (d) of providing a current collector 12, and disposing the carbon nanotube film 14 on a surface of the current collector 12 can, advantageously, be further provided after step (c). The carbon nanotube film 14 can, suitably, be made to adhere to the surface of the current collector 12 by a binder.

It is to be understood that, the carbon nanotube film 14 is adhesive due to the large specific area thereof, thus, the carbon nanotube film 14 can be directly adhered to the current collector 12 by van der Waals attractive force.

In step (d), the current collector 12 can, beneficially, be a metal substrate. Quite suitably, the metal substrate is a copper sheet.

It is to be understood that, the current collector 12 in the anode 10 of the lithium battery in the present embodiment is optional. In other embodiments, the anode 10 of the lithium battery may only include the carbon nanotube film 14. Due to the free-standing and stable film structure, the carbon nanotube film 14 can be used as the anode 10 in the lithium battery without the current collector 12.

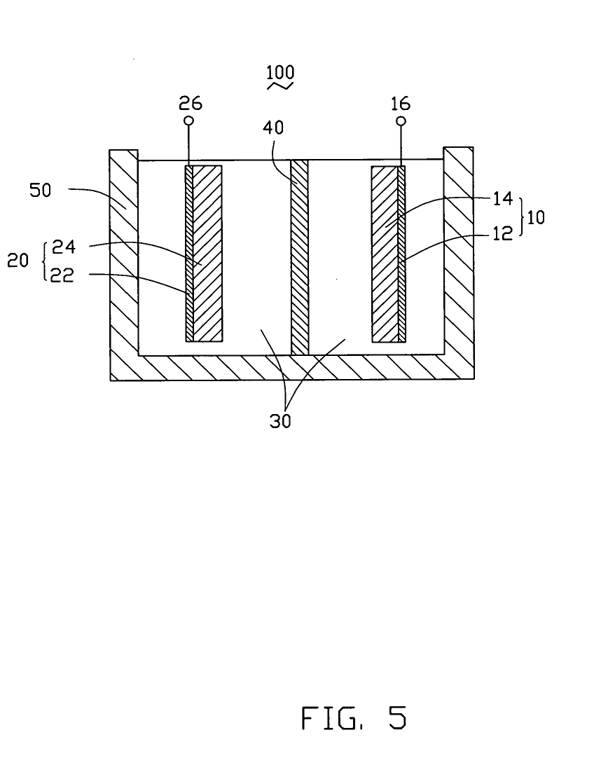

Referring to FIG. 5, a lithium battery 100 includes a container 50, an anode 10, a cathode 20, an electrolyte 30, and a separator 40. The anode 10, the cathode 20, the electrolyte 30, and the separator 40 are disposed in the container 50. The container 50 is filled the electrolyte 30. The cathode 20 and the anode 10 are separated by the separator 40. The cathode 20 includes a positive current collector 22 and an active material 24 disposed thereon. The anode 10 includes a negative current collector 12 and a carbon nanotube film 14 disposed thereon. The active material 24 and the carbon nanotube film face each other. A positive terminal 26 and a negative terminal 16 are respectively disposed on the tops of the positive current collector 22 and the negative current collector 12.

The materials of the cathode 20, the separator 40, and the electrolyte 30 may be common materials known in the art. In the present embodiment, the cathode active material is lithium foil or lithium transition metal oxides. The electrolyte is 1 mol/L Lithium Hexafluorophosphate (LiPF₆) in Ethylene Carbonate (EC) and Diethyl Carbonate (DEC). A volume ratio of EC and DEC is 1:1. A weight of the anode is about 50 micrograms. The material of the separator is polyolefin.

Referring to table 1, the cycle performance of the carbon-nanotube-based anode of lithium battery at room temperature is shown. The anode of the lithium battery has high charge/discharge efficiency, high capacity, and good cycle performance. The discharge capacity of the first cycle of the lithium battery is above 700 mAh/g. The efficiency of the first cycle is above 140%. After 11 cycles, the capacity retention is above 91%.

TABLE 1

| | Charge Current | Discharge Current | |
|---|---|---|---|
| Cycle Number | (mAh) | (mAh) | Efficiency |
| 1 | 0 | 0.1094 | 0 |
| 2 | 0.0257 | 0.0382 | 148.8 |
| 3 | 0.0273 | 0.0321 | 117.5 |
| 4 | 0.0254 | 0.0293 | 115.2 |
| 5 | 0.0245 | 0.0277 | 113.1 |
| 6 | 0.0243 | 0.0271 | 111.3 |
| 7 | 0.0239 | 0.0264 | 110.6 |
| 8 | 0.0236 | 0.026 | 109.8 |
| 9 | 0.023 | 0.0259 | 109.3 |
| 10 | 0.0227 | 0.0257 | 108.1 |
| 11 | 0.0229 | 0.0259 | 108.6 |
| 12 | 0.0226 | 0.0274 | 107 |
| 13 | 0.0227 | 0 | 0 |

It will be apparent to those having ordinary skill in the field of the present invention that, the composition of the cathode and the electrolyte are not limited to the above-mentioned materials. The carbon nanotube film 14 is essentially free of binder and includes a large amount of micropores. The intercalation amount of lithium ions can be enhanced due to the special microporous film structure of the anode. The stability of the SEI layer formed in the first cycle of charge and discharge can be improved due to the carbon nanotube film 14. As such, the electrolyte used in the lithium battery can be selected from a wider range of common electrolytes. Additionally, the carbon nanotubes are uniformly dispersed in the carbon nanotube film. Accordingly, the carbon nanotube film 14 has excellent tensile strength. Further, the method for making the anode is simple and can be used in mass production.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

1. An anode of a lithium battery, comprising:
a carbon nanotube film comprising a plurality of tangled carbon nanotubes.

2. The anode of the lithium battery as claimed in claim 1, wherein a length of the carbon nanotubes is greater than 10 microns.

3. The anode of the lithium battery as claimed in claim 1, wherein the carbon nanotubes are tangled together due to a van der Waals attractive force therebetween to form a network structure.

4. The anode of the lithium battery as claimed in claim 1, wherein the carbon nanotubes is isotropically arranged, disordered, and uniformly dispersed in the carbon nanotube film.

5. The anode of the lithium battery as claimed in claim 1, wherein the carbon nanotube film comprises a large amount of micropores, and a diameter of the micropores is less than about 100 microns.

6. The anode of the lithium battery as claimed in claim 1, wherein a thickness of the carbon nanotube film is in the approximate range from 1 micron to 2 millimeters.

7. The anode of the lithium battery as claimed in claim 1, further comprising a current collector, and the carbon nanotube film is disposed on a surface of the current collector.

8. The anode of the lithium battery as claimed in claim 1, wherein the current collector is a metallic substrate.

9. A method for fabricating an anode of a lithium battery, the method comprising the steps of:
(a) providing a plurality of carbon nanotubes;
(b) adding the plurality of carbon nanotubes to a solvent to get a carbon nanotube floccule structure in the solvent; and
(c) separating the carbon nanotube floccule structure from the solvent, shaping the separated carbon nanotube floccule structure into a carbon nanotube film, and thereby, achieving the anode.

10. The method as claimed in claim 9, wherein in step (b), the process of flocculating the carbon nanotubes is selected from the group consisting of ultrasonic dispersion of the carbon nanotubes and agitating the carbon nanotubes.

11. The method as claimed in claim 9, wherein in step (c), the process of separating the floccule structure from the solvent further comprises the substeps of:
(c1) filtering out the solvent to obtain the carbon nanotube floccule structure; and
(c2) drying the carbon nanotube floccule structure to obtain the separated carbon nanotube floccule structure.

12. The method as claimed in claim 9, wherein in step (c), the process of shaping the carbon nanotube floccule structure comprises the substeps of:
(c3) putting the separated carbon nanotube floccule structure into a container, and spreading the carbon nanotube floccule structure to form a predetermined structure;
(c4) pressing the spread carbon nanotube floccule structure with a certain pressure to yield a desirable shape; and
(c5) removing the residual solvent contained in the spread floccule structure to form the carbon nanotube film.

13. The method as claimed in claim 9, wherein step (c) further comprises the substeps of:
(c1′) providing a microporous membrane and an air-pumping funnel;
(c2′) filtering out the solvent from the flocculated carbon nanotubes through the microporous membrane using the air-pumping funnel; and
(c3′) air-pumping and drying the flocculated carbon nanotubes attached on the microporous membrane.

14. The methods as claimed in claim 9, further comprising a step of providing a current collector, and disposing the carbon nanotube film on the current collector after step (c).

15. The methods as claimed in claim 14, the carbon nanotube film can be adhered to the current collector by van der Waals attractive force therebetween, or by a binder.

16. The method as claimed in claim 9, wherein the carbon nanotube film is cut into a predetermined shape and size.

17. A lithium battery, comprising:
an anode comprising a carbon nanotube film, the carbon nanotube film comprising a plurality of tangled carbon nanotubes.
a cathode;
a separator used to separate the anode from the cathode;
a container having the anode, the cathode, and the separator disposed therein; and
an electrolyte filled in the container.

18. The lithium battery as claimed in claim 17, wherein the material of cathode is lithium foils or lithium transition metal oxides.

19. The lithium battery as claimed in claim 17, wherein the electrolyte comprises lithium hexafluorophosphate, ethylene carbonate, and diethyl carbonate.

20. The lithium battery as claimed in claim 19, wherein a ratio of volume of ethylene carbonate and diethyl carbonate is about 1:1.
